(19) United States
(12) Patent Application Publication
(10) Pub. No.: US 2026/0129685 A1
(43) Pub. Date: May 7, 2026

(54) ON-DEMAND SYSTEM INFORMATION REQUEST

(71) Applicant: Lenovo (United States) Inc., Morrisville, NC (US)

(72) Inventors: Prateek Basu Mallick, Dreieich (DE); Alexander Golitschek Edler von Elbwart, Darmstadt (DE); Joachim Löhr, Wiesbaden (DE)

(73) Assignee: Lenovo (United States) Inc., Morrisville, NC (US)

(21) Appl. No.: 18/940,774

(22) Filed: Nov. 7, 2024

(51) Int. Cl. H04W 74/0833; H04W 52/02; H04W 74/00; H04W 74/08

(52) U.S. Cl. CPC H04W 74/0833; H04W 52/0206; H04W 74/006; H04W 74/0891

(57) ABSTRACT

Various aspects of the present disclosure relate to on-demand system information request. An apparatus, such as a UE, receives, from a serving cell, a configuration that indicates first configuration information for requesting system information block 1 (SIB1) and second configuration information that indicates one or more physical random access channel (PRACH) resources for requesting SIB1 of at least one network energy saving (NES) cell. The UE receives, from the serving cell, information that indicates a synchronization signal block (SSB) subcarrier offset and a physical downlink control channel (PDCCH) configuration for SIB1 acquisition from the at least one NES cell. The UE transmits, to the at least one NES cell, a SIB1 request based at least in part on the first configuration information and a failed SIB1 acquisition.

### TECHNICAL FIELD

The present disclosure relates to wireless communications, and more specifically to an on-demand system information block (SIB) request.

### BACKGROUND

A wireless communications system may include one or multiple network communication devices, which may be otherwise known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive, from a serving cell, a configuration that indicates first configuration information for requesting SIB1 and second configuration information that indicates one or more physical random access channel (PRACH) resources for requesting SIB1 of at least one network energy saving (NES) cell; receive, from the serving cell, information that indicates a synchronization signal block (SSB) subcarrier offset and a physical downlink control channel (PDCCH) configuration for SIB1 acquisition from the at least one NES cell; and transmit, to the at least one NES cell, a SIB1 request based on the first configuration information and a failed SIB1 acquisition.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from a serving cell, a configuration that indicates first configuration information for requesting SIB1 and second configuration information that indicates one or more PRACH resources for requesting SIB1 of at least one NES cell; receive, from the serving cell, information that indicates a SSB subcarrier offset and a PDCCH configuration for SIB1 acquisition from the at least one NES cell; and transmit, to the at least one NES cell, a SIB1 request based on the first configuration information and a failed SIB1 acquisition.

A method performed or performable by a UE for wireless communication is described. The method may include receiving, from a serving cell, a configuration that indicates first configuration information for requesting SIB1 and second configuration information that indicates one or more PRACH resources for requesting SIB1 of at least one NES cell; receiving, from the serving cell, information that indicates a SSB subcarrier offset and a PDCCH configuration for SIB1 acquisition from the at least one NES cell; and transmitting, to the at least one NES cell, a SIB1 request based on the first configuration information and a failed SIB1 acquisition.

Some implementations of the UE, the processor, and the method described herein, the UE, the processor, and the method may further be configured to, capable of, operable to camp on the at least one NES cell for service based on a successful SIB1 acquisition. In some implementations of the UE, the processor, and the method described herein, the NES cell is a subsequent serving cell for the UE.

Some implementations of the UE, the processor, and the method described herein, the UE, the processor, and the method may further be configured to, capable of, operable to receive, from the at least one NES cell, an SSB that includes a master information block (MIB) and a physical broadcast channel (PBCH).

In some implementations of the UE, the processor, and the method described herein, the SSB subcarrier offset is an integer value that equals a frequency domain offset between an SSB and a resource block grid (RBG) for a number (e.g., quantity) of subcarriers.

Some implementations of the UE, the processor, and the method described herein, the UE, the processor, and the method may further be configured to, capable of, operable to: based on the received information that indicates the SSB subcarrier offset and the PDCCH configuration for SIB1 acquisition, and based on the received SSB from the at least one NES cell indicating the SSB subcarrier offset and the PDCCH configuration for SIB1 acquisition, process the information received from the serving cell for SIB1 acquisition from the at least one NES cell.

Some implementations of the UE, the processor, and the method described herein, the UE, the processor, and the method may further be configured to, capable of, operable to monitor for a broadcast SIB1 transmission based on one or more of the SSB subcarrier offset or the PDCCH configuration for SIB1 acquisition from the at least one NES cell; and determine a failed attempt for SIB1 acquisition based on the monitoring. In some implementations of the UE, the processor, and the method described herein, the SIB1 request is transmitted based on the determined failed attempt for SIB1 acquisition. In some implementations of the UE, the processor, and the method described herein, the PDCCH configuration includes at least one or more of a common control resource set (CORESET), a common search space (CSS), or other PDCCH parameters.

An NE (e.g., a base station, gNB, and the like) for wireless communication is described. The NE may be configured to, capable of, or operable to perform one or more operations as described herein. For example, the NE may be configured to, capable of, or operable to transmit, to a UE, a configuration that indicates first configuration information for requesting SIB1 and second configuration information that indicates one or more PRACH resources for requesting a SIB1 of at least one NES cell; and transmit, to the UE, information that indicates a SSB subcarrier offset and a PDCCH configuration for SIB1 acquisition from the at least one NES cell, where a SIB1 request from the UE to the at least one NES cell is based on the first configuration information and a failed SIB1 acquisition.

A processor (e.g., a standalone processor chipset, or a component of an NE) for wireless communication is described. The processor may be configured to, capable of, or operable to perform one or more operations as described herein. For example, the processor may be configured to, capable of, or operable to transmit, to a UE, a configuration that indicates first configuration information for requesting SIB1 and second configuration information that indicates one or more PRACH resources for requesting a SIB1 of at least one NES cell; and transmit, to the UE, information that indicates a SSB subcarrier offset and a PDCCH configuration for SIB1 acquisition from the at least one NES cell, where a SIB1 request from the UE to the at least one NES cell is based on the first configuration information and a failed SIB1 acquisition.

A method performed or performable by an NE (e.g., a base station, gNB, and the like) for wireless communication is described. The method may include transmitting, to a UE, a configuration that indicates first configuration information for requesting SIB1 and second configuration information that indicates one or more PRACH resources for requesting a SIB1 of at least one NES cell; and transmitting, to the UE, information that indicates a SSB subcarrier offset and a PDCCH configuration for SIB1 acquisition from the at least one NES cell, where a SIB1 request from the UE to the at least one NES cell is based on the first configuration information and a failed SIB1 acquisition.

### BRIEF DESCRIPTION OF THE DRAWINGS

FIG. 1 illustrates an example of a wireless communications system in accordance with aspects of the present disclosure.

FIG. 2 illustrates an example time-frequency structure of an SS/PBCH block, in accordance with aspects of the present disclosure.

FIG. 3 illustrates an example timing of candidate SS/PBCH blocks within a SS burst set, in accordance with aspects of the present disclosure.

FIG. 4 illustrates an example signal diagram of MIB and SIB transmissions, in accordance with aspects of the present disclosure.

FIG. 5 illustrates an example procedure for acquiring an on-demand SIB1, in accordance with aspects of the present disclosure.

FIG. 6 illustrates an example of SIB1 request configuration information, in accordance with aspects of the present disclosure.

FIG. 7 illustrates an example representation of MIB, in accordance with aspects of the present disclosure.

FIG. 8 illustrates an example of L1/L2 triggered mobility (LTM) cell switch command medium access control-control element (MAC-CE), in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of a NE in accordance with aspects of the present disclosure.

FIG. 12 illustrates a flowchart of a method performed by a UE in accordance with aspects of the present disclosure.

FIG. 13 illustrates a flowchart of a method performed by a NE in accordance with aspects of the present disclosure.

### DETAILED DESCRIPTION

A wireless communications system supports wireless communications, and may include one or more UEs or NEs (e.g., base stations, such as eNBs, gNBs, or network entities, satellites, and/or other NE, capable of transmitting and/or receiving signaling (e.g., packets, control information, data). Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth. In some cases, the NE may expend substantial energy transmitting SSBs, as well as for PBCH that includes MIB and SIB1. In some networks, such as a legacy 5G network, the SIBs, apart from SIB1, can be provided on-demand. Accordingly, aspects of this disclosure are directed to solutions for energy savings with respect to SSBs and SIB1. For example, in one or more implementations, the SSBs and SIB1 may be provided on an as-needed or as-requested basis. Alternatively, or in addition, rather than the NE providing the SSBs and SIB1, an anchor cell may be used as a proxy (e.g., for time-frequency synchronization, SIB1).

Aspects of this disclosure are directed to signaling that supports on-demand SIB1 for UEs in an idle or inactive mode, including triggering an uplink (UL) wake-up-signal using a legacy signal and/or channel, a wake-up signal (WUS) configuration provisioning to a UE, and/or information exchange between NE (e.g., gNBs), such as for the WUS configuration. As described herein, the techniques for network energy savings decreases or minimizes the SIB1 transmissions from the NE, where a UE can request SIB1 on an on-demand basis. For example, a UE request for SIB1 is at least one UL transmission in the form of PRACH transmission, and the resources for PRACH transmission and or PRACH preamble used in the transmission can identify that the UE is requesting SIB1.

However, in this scenario, it is also likely that a serving cell or NES cell is broadcasting SIB1 when a UE intends to request SIB1. For example, a UE may have determined that the SIB1 of a NES cell is being provided on an on-demand basis, and the UE has acquired a SIB1 request configuration (e.g., a PRACH configuration) from the same NES cell, either earlier or from a helping anchor cell. The NES cell may already be broadcasting SIB1 if another UE has also initiated a request for SIB1, or based on a configuration and/or implementation of the cell. In this scenario, a UE implementation would be to first attempt to acquire SIB1 from an already potential SIB1 broadcast, which can be performed utilizing conventional techniques. However, as described in one or more implementations, when the UE cannot acquire a broadcasted SIB1 from the cell, the UE can initiate a SIB1 request to the NES cell. A NES cell (or cells) can be implemented in a wireless communications system to help reduce energy consumption in the network. These NES cells minimize the transmission of system information (SI) and other control signals when they are not actively being utilized, which helps facilitate conserving network power. By performing the described techniques, a UE in a wireless communications system may avoid unnecessary transmissions and reduce interference for other UEs in proximate to the UE in the wireless communications system.

Aspects of the disclosure include an anchor cell (or serving cell) that provides information to enable a UE to acquire SIB1 broadcast of an on-demand SIB1 NES cell. The information provided by the serving cell includes a multi-bit integer (e.g., a 5-bit integer) that represents the legacy K_{SSB}, and a PDCCH configuration for receiving SIB1 (CORESET0 and Search Space0). The UE receives the information from both the serving cell (or previously from SIB of a NES cell), and from MIB of the NES cell. In one or more implementations, the UE uses the information received from the serving cell to acquire a broadcasted SIB1 of the NES cell. Alternatively, the UE uses the information received last from either the serving cell or the NES cell to acquire a broadcasted SIB1 of the NES cell. In one or more implementations, the UE does not bar the NES cell if the SIB1 broadcast acquisition fails, but rather the UE initiates a SIB1 on-demand request. The parameters are configurable to control how long the UE attempts to acquire the broadcasted SIB1.

Aspects of the present disclosure are described in the context of a wireless communications system.

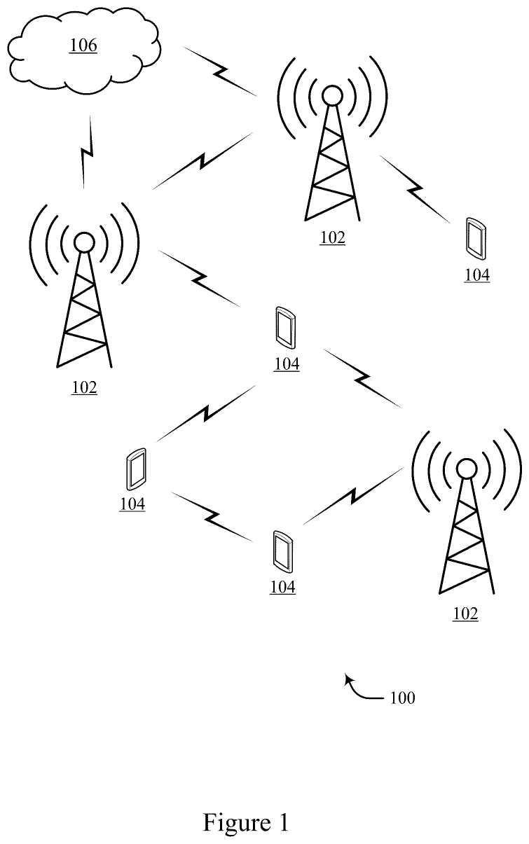

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives, from a NE 102 (e.g., a serving cell), a SIB1 request configuration that includes PRACH resource information usable to request a SIB1 of at least one NES cell (which may also be implemented as a NE 102). The UE 104 receives, from the NE 102, a SSB subcarrier offset and a PDCCH configuration usable to acquire a broadcasted SIB1 from the at least one NES cell. The UE 104 attempts to acquire the broadcasted SIB1 using the SSB subcarrier offset and the PDCCH configuration. The UE transmits, to the at least one NES cell, a SIB1 request based on the SIB1 request configuration and an unsuccessful attempt to acquire the broadcasted SIB1. Alternatively, the UE 104 camps on the at least one NES cell for service based on a successful attempt to acquire the broadcasted SIB1, and the NES cell is a subsequent serving cell for the UE.

In a further example, the NE 102 transmits, to the UE 104, a SIB1 request configuration that includes PRACH resource information usable by the UE to request a SIB1 of at least one NES cell. The NE 102 transmits, to the UE 104, a SSB subcarrier offset and a PDCCH configuration usable by the UE to acquire a broadcasted SIB1 from the at least one NES cell, where a SIB1 request from the UE to the at least one NES cell is based on the SIB1 request configuration and an unsuccessful attempt by the UE to acquire the broadcasted SIB1. Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to network energy savings, emissions and energy consumption by the various devices of a wireless communications system (e.g., a telecommunication system) may adversely contribute to the climate. Additionally, the operating expenses to implement and maintain a telecommunication service can be immense. In telecoms, a number of industry-specific factors rooted in countering rising network costs have further shaped efficiency efforts. A continued rise in mobile data traffic, combined with the rising costs of spectrum, capital investment, and ongoing RAN maintenance and upgrades, energy-saving measures in network operations are essential. 5G New Radio (NR) offers a significant energy-efficiency improvement per gigabyte over previous generations of mobility. However, new 5G use cases and the adoption of mm Wave utilizes more cell sites and antennas, which may lead to the prospect of a more efficient network that may result in higher emissions.

Overall, network energy saving is an important aspect for environmental sustainability, such as to reduce the environmental impact (greenhouse gas emissions), and for operational cost savings. As 5G is becoming pervasive across industries and geographical areas, handling more advanced services and applications requiring very high data rates (e.g., XR), networks are becoming denser, using more antennas, larger bandwidths, and more frequency bands. Energy consumption accounts for a significant energy cost of a mobile network. Most of the energy consumption occurs at the radio access network, and in particular, at the active antenna unit (AAU), with data centers and fiber transport accounting for a smaller share. The power consumption of a radio access can be split into two parts, for example, the dynamic part which is only consumed when data transmission or reception is occurring, and the static part which is energy consumed consistently to maintain the necessary operation of the radio access devices, even when the data transmission and reception is not occurring.

With reference to PRACH in 5G and preamble transmission, a UE can select a random access preamble from a set of predefined preambles. These preambles can be of roughly two categories, for example, short preamble format and long preamble format. The UE may also select a random sequence number for the preamble. After choosing the preamble and sequence number, the UE transmits the preamble on the PRACH.

With reference to 5G NR and synchronization signal/PBCH block (SS/PBCH block), a cell search is the procedure for a UE to acquire time and frequency synchronization with a serving cell, and to detect physical layer cell ID (PCI) of the cell. During cell search operations, which are carried out when a UE is powered ON, mobility in connected mode, idle mode mobility (e.g. reselections), inter-RAT mobility to NR system, etc., the UE uses NR synchronization signals and PBCH to derive the necessary information required to access the cell. Similar to LTE, two types of synchronization signals are defined for NR, for example, primary synchronization signal (PSS) and the secondary synchronization signal (SSS). The SS/PBCH block includes PSS, SSS, and PBCH. Synchronization signals can also be used by the UE for RSRP and RSRQ measurements.

With reference to physical-layer cell identity (PCI), there are 1,008 unique PCIs defined in 5G NR, double of that in LTE (504). The 1,008 NR PCIs are divided into 336 unique PCI groups and each group consists of three different identities. The PCI of a cell can be calculated using:

$${{N}_{ID}}^{Cell} = 3 * {{N}_{ID}}^{( 1 )} + {{N}_{ID}}^{( 2 )} where {{N}_{ID}}^{( 1 )} ∈ \{ 0 , 1 , … , 335 \} and {{N}_{ID}}^{( 2 )} ∈ \{ 0 , 1 , 2 \}$$

The UE derives a PCI group number N_{ID}⁽¹⁾ from SSS and physical-layer identity N_{ID}⁽²⁾ from PSS.

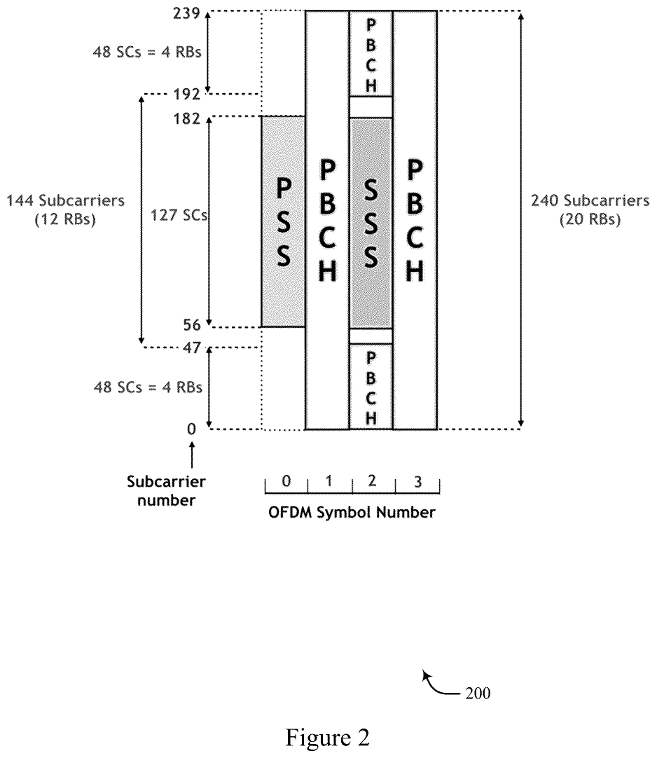

FIG. 2 illustrates an example time-frequency structure 200 of an SS/PBCH block, in accordance with aspects of the present disclosure. In this example time-frequency structure 200, PSS, SSS, and PBCH are always together in consecutive OFDM symbols. Each SS/PBCH block occupies 4 OFDM symbols in the time domain and is spread over 240 subcarriers (20 RBs) in the frequency domain. The PSS occupies a first OFDM symbol and spans over 127 subcarriers. The SSS is located in the third OFDM symbol and spans over 127 subcarriers. There are 8 un-used subcarriers below SSS and 9 un-used subcarriers above SSS. The PBCH occupies two full OFDM symbols (second and fourth) spanning 240 subcarriers and in the third OFDM symbol spanning 48 subcarriers below and above SSS. This results in PBCH occupying 576 subcarriers across three OFDM symbols (240+48+48+240=576). The PBCH DM-RS occupies 144 REs which is one-fourth of total REs and remaining for PBCH payload (576−144=432 REs).

With reference to frequency resources occupied by SS/PBCH block, the table below summarizes resources within an SS/PBCH block for PSS, SSS, PBCH, and DM-RS for PBCH. The complex-valued symbols corresponding to resource elements denoted as ‘Set to 0’ in the table below are set to zero. As indicated in the table, the location of PBCH DM-RS depends on PCI (v=N_{ID}^{cell} mod 4) of the cell (where PCI is already determined by the UE using PSS/SSS).

| Channel or | OFDM symbol number ‘l'relative | Subcarrier number ‘k’ relative |
|---|---|---|
| Signal | to the start of an SS/PBCH block | to the start of an SS/PBCH block |
| PSS | 0 | 56, 57, . . . , 182 |
| SSS | 2 | 56, 57, . . . , 182 |
| Set to ‘0’ | 0 | 0, 1, . . . , 55, 183, 184, . . . , 239 |
| | 2 | 48, 49, . . . , 55, 183, 184, . . . , 191 |
| PBCH | 1, 3 | 0, 1, . . . , 239 |
| | 2 | 0, 1, . . . , 47, |
| | | 192, 193, . . . , 239 |
| DM-RS for | 1, 3 | 0 + ν, 4 + ν, 8 + ν, . . . , 236 + ν |
| PBCH | 2 | 0 + v, 4 + v, 8 + v, . . . , 236 + v |
| | | 192 + ν, 196 + ν, . . . , 236 + v |

With reference to SSB details in time domain, each SS/PBCH block spans across 4 OFDM symbols in the time domain. A SS/PBCH block is periodically transmitted with a periodicity of 5 ms, 10 ms, 20 ms, 40 ms, 80 ms or 160 ms. While longer SS/PBCH block periodicities enhances network energy performance, the shorter periodicities facilitate faster cell search for UEs. A UE can assume a default periodicity of 20 ms during initial cell search or idle mode mobility. With reference to SS burst set, to enable beam-sweeping for PSS/SSS and PBCH, SS burst sets are defined. An SS burst set includes a set of SS/PBCH blocks, where each SS/PBCH block can potentially be transmitted on a different beam. A SS burst set consists of one or more SS/PBCH blocks, and the SS/PBCH blocks in the SS burst set are transmitted in time-division multiplexing fashion. An SS burst set is always confined to a 5 ms window and is either located in a first-half or in the second-half of a 10 ms radio frame. The network sets the SS/PBCH block periodicity via RRC parameter ssb-PeriodicityServingCell which can take values in the range {5 ms, 10 ms, 20 ms, 40 ms, 80 ms, 160 ms}. The maximum number of candidate SS/PBCH blocks (Lₘₐₓ) within an SS burst set depends upon the carrier frequency/band, as shown in the table below.

| | Max. No. of Candidate SS/PBCH blocks |
|---|---|
| Carrier Frequency | within SS Burst Set (Lmax) |
| f_{c} ≤ 3 GHz* | 4 |
| 3 GHz* < f_{c} ≤ 6 GHz | 8 |
| f_{c} > 6 GHz | 64 |

*SCS = 30 kHz case: for paired spectrum, 3 GHz, for unpaired spectrum, 2.4 GHz is used

Within a 5 ms half frame, the starting OFDM symbol index for a candidate SS/PBCH block within SS burst set depends upon subcarrier spacing (SCS) and carrier frequency/band (summarized in the table below).

| | OFDM starting | | | |
|---|---|---|---|---|
| | symbols of the | fc ≤ 3 GHz* | 3 GHz* < fc ≤ 6 GHz | fc > 6 GHz |
| SCS | candidate SSBs | Lmax = 4 | Lmax = 8 | Lmax = 4 |
| CaseA: | {2, 8} + 14n | n = 0, 1 | n = 0, 1, 2, 3 | NA |
| 15 kHz | | (2, 8, 16, 22} | {2, 8, 16, 22, 30, 36, 44, 50} | |
| CaseB: | {4, 8, 16, 20} + 28n | n = 0 | n = 0, 1 | NA |
| 30 kHz | | {4, 8, 16, 20} | {4, 8, 16, 20, 32, 36, 44, 48} | |
| CaseC: | {2, 8} + 14n | n = 0, 1 | n = 0, 1, 2, 3 | NA |
| 30 kHz | | {2, 8, 16, 22} | {2, 8, 16, 22, 30, 36, 44, 50} | |
| CaseD: | {4, 8, 16, 20} + 28n | NA | NA | n = 0, 1, 2, 3, 5, 6, 7, 8, 10, |
| 120 kHz | | | | 11, 12, 13, 15, 16, 17, 18 |
| | | | | {4, 8, 16, 20 . . . |
| | | | | 508, 512, 520, 524} |
| CaseE: | {8, 12, 16, 20, 32, 36, | NA | NA | n = 0, 1, 2, 3, 5, 6, 7, 8 |
| 240 kHz | 40, 44} + 56n | | | {8, 12, 16, 20 . . . |
| | | | | 480, 484, 488, 492} |

*SCS = 30 kHz case: for paired spectrum, 3 GHz, for unpaired spectrum, 2.4 GHz is used
Entries within curly brackets denote OFDM starting symbols for the candidate SS/PBCH blocks

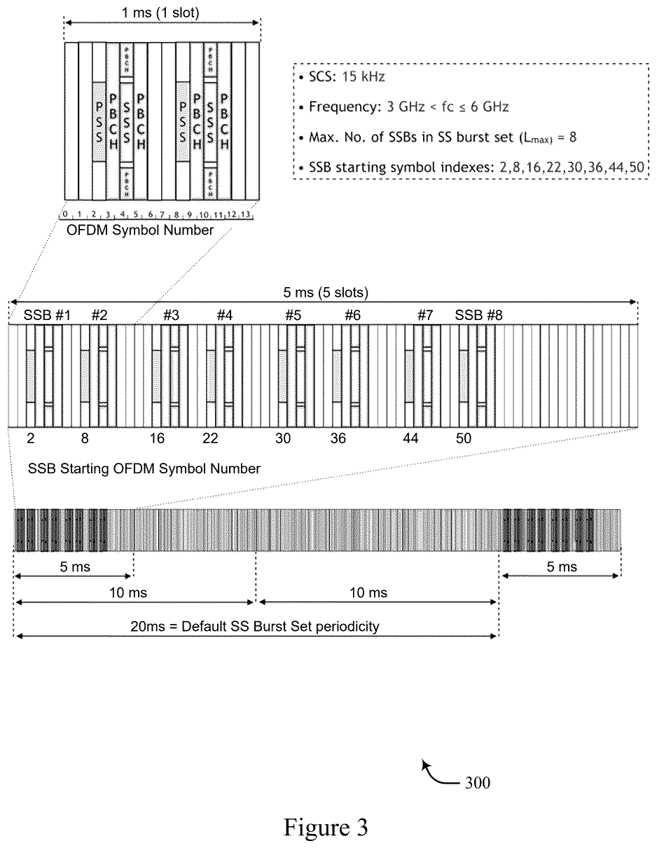

FIG. 3 illustrates an example 300 of timing of candidate SS/PBCH blocks within a SS burst set, in accordance with aspects of the present disclosure. Note that when the network is not using beam forming, it may transmit only one SS/PBCH block and, hence, there can only be one SS/PBCH block starting position. As an example, the timing of candidate SS/PBCH blocks within the SS burst set is illustrated in this example 300 for the case of SCS=15 kHz and carrier frequency between 3 GHz and 6 GHz.

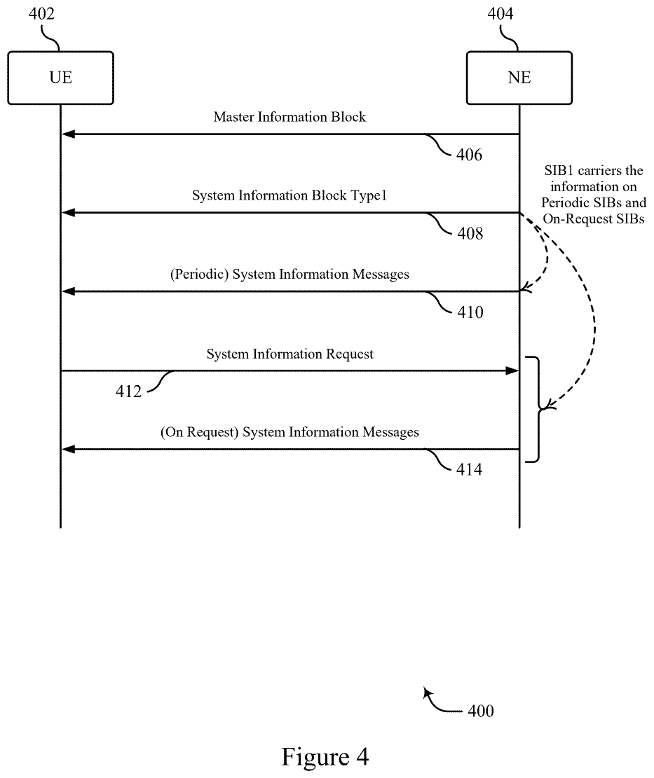

FIG. 4 illustrates an example signal diagram 400 of MIB and SIB transmissions, in accordance with aspects of the present disclosure. In this example 400, the overall MIB/SIB transmission and relationships among SIBs is illustrated, with reference to a UE 402 and a NE 404 (e.g., a gNB, NR). The NE 404 transmits a MIB to the UE 402 (at 406), and the UE receives the MIB. The NE 404 transmits a SIB1 to the UE 402 (at 408), and the UE receives the SIB1. The NE 404 transmits periodic system information messages to the UE 402 (at 410), and the UE receives the system information messages. The UE 402 transmits a system information request (SIR) to the NE 404 (at 412), and the NE receives the SIR. The NE 404 transmits (on request) the SIR to the UE 402 (at 414), and the UE receives the SIR.

The characteristics of MIB and scheduling include transmitted over BCH or PBCH (noting that PBCH is transmitted as a part of SSB); transmitted with the periodicity of 80 ms and within this 80 ms repetitive transmission happens; for initial cell selection, a UE may assume that half frames with SS/PBCH blocks occur with a periodicity of 2 frames; and includes the parameters to decode SIB1.

With reference to subCarrierSpacingCommon, this indicates the subcarrier spacing for SIB1, Msg.2/4 for initial access and SI-messages. Interpretation of this value varies with frequency range. For example, for FR1, scs15or60 is 15 Khz and scs30or120 is 30 Khz. For FR2, scs15or60 is 60 Khz and scs30or120 is 120 Khz. The ssb-subcarrierOffset corresponds to k_ssb and indicates the frequency domain offset between SSB and the overall resource block grid in a number of subcarriers. If k_ssb requires the value higher than 15, it is represented by the combination of a PBCH data field and ssb-subcarrierOffset. The DMRS-TypeA-Position indicates a position of (first) DL DM-RS. The pdcchConfigSIB1 indicates a bandwidth for PDCCH/SIB, a common CORESET, a common search space, and PDCCH parameters. This corresponds to RMSI-PDCCH-Config. The PDCCH parameters may include an aggregation level (AL), search space, control channel elements (CCEs), a DCI format, etc.

With reference to 5G SIB1, the overall characteristics of SIB1 include transmitted over DL-SCH (noting that SIB1 is the first RRC message (except MIB)). Accordingly, the UE needs to be able to decode SIB1 without much information from an OTA signaling message. Therefore, 3GPP defines very specific procedure to transmit and/or decode DCI and PDSCH for SIB1. The characteristics of SIB1 also include transmitted with the periodicity of 160 ms and within this 160 ms repetitive transmission happens. Additional characteristics include information regarding the availability and scheduling (e.g. periodicity, SI-window size) of other SIB1, as well as the characteristics indicate whether other SIBs are provided via periodic broadcast basis or only on an on-demand basis. If SIBs other than SIB1 are provided on-demand, information is included for the UE to perform SI request.

Aspects of the present disclosure include solutions to address that a NES cell may be temporarily broadcasting SIB1 if another UE previously requested the SIB1, or based on configuration and/or implementation of the NES cell. In one or more implementations, a UE first attempts to acquire SIB1 from a potential SIB1 broadcast. However, if the UE fails to acquire any broadcasted SIB1 from the NES cell, the UE can initiate a SIB1 request. This avoids unnecessary UE transmissions and reduces interference for other UEs in the surrounding environment. The one or more implementations provide for which SSB subcarrier offset and PDCCH configuration is used by the UE to receive SIB1. Another consideration includes whether a SIB1 acquisition failure should bar the cell for a time duration (e.g., up to 300 seconds). Aspects of the disclosure include indications of the information that can be broadcast from a serving cell, or the information in SIB of a NES cell, and subsequently, a prioritized scheme is used to acquire a broadcasted SIB1. Aspects of the disclosure also include features to avoid unnecessarily barring the NES cell.

In one or more implementations, a serving cell provides information, such as a legacy K_{SSB} parameter, which is the frequency domain offset between SSB and the overall resource block grid in a number of subcarriers, and is an extension of a SSB subcarrier offset. Generally, the value range of the SSB subcarrier offset may be extended by an additional most significant bit encoded within PBCH to form the K_{SSB}. However, when included as the information in a serving cell, this can be indicated as a single 5-bit long integer value (i.e., the UE need not be provided separately with a SSB subcarrier offset value, and an additional most significant bit encoded within PBCH).

In aspects of the described techniques, network energy saving will minimize SIB1 transmissions from the network. If a SIB1 transmission is primarily (or only) on an on-demand basis, a UE can initiate a SIB1 request, which includes at least one UL transmission in the form of PRACH transmission. The resources for a PRACH transmission and or a PRACH preamble used in the transmission can identify that the UE is requesting SIB1. However, it is also likely that a cell (e.g., NES cell) is broadcasting SIB1 when a UE intends to request SIB1 based on a determination that the SIB1 of the NES cell is being provided on an on-demand basis, and the UE has acquired the SIB1 request configuration (e.g., a PRACH configuration from the same (NES) cell previously, or from a helping anchor cell or serving cell). The NES cell may be broadcasting SIB1 due to another UE having requested SIB1, or based on a configuration and/or implementation of the cell. In this scenario, the UE implementation first attempts to acquire SIB1 from a potential SIB1 broadcast (e.g., as legacy). However, when the UE cannot acquire a broadcasted SIB1 from the cell (e.g., NES cell), a SIB1 request is initiated, which saves unnecessary UE transmissions and reduces interference for other UEs in the surrounding environment.

The 3GPP has made some agreements that uses the MIB information to indicate legacy UEs that SIB1 is not being provided in the cell and they are still discussing if specific K_{SSB} values >23/11 (for FR1 and FR2 respectively) can be used to indicate another GSCN where the legacy UE find SIB1. Except for K_{SSB} values=30/14, the other values in this range will lead legacy UEs to look for SIB1 “elsewhere”—whereas the NES on-demand SIB1 cell should not be transmitting SIB1 at this “elsewhere” location—otherwise, it will not be saving energy. Accordingly, aspects of the described techniques avoid legacy UEs unnecessarily searching for SIB1. To this end, K_{SSB} is restricted to values that will avoid legacy UEs unnecessarily searching for SIB1 when the same is not transmitted in Sync raster. However, if there are any reasons to use specific K_{SSB} values >23/11, then this disclosure also enables a UE to determine whether SIB1 is currently broadcasted before it proceeds to initiate a SIB1 request from the NES cell.

If the ssb-SubcarrierOffset is used for a special purpose and cannot provide a valid SSB subcarrier offset, and the UE still needs to verify whether it can receive broadcasted SIB1, the K_{SSB} should be provided along with the WUS configuration by the cell A. This assumes that the PDCCH-ConfigSIB1 can be used directly from the MIB of the NES cell (i.e., RANI has no need to repurpose this IE). Conservatively, both K_{SSB} and PDCCH-ConfigSIB1 can be provided in a new SIB of cell A along with an already agreed WUS configuration. So, both K_{SSB} and PDCCH-ConfigSIB1 can be provided in a new SIB of cell A along with an already agreed WUS configuration, at least if the detected K_{SSB} in the NES MIB is between 24 and 29.

The legacy UEs (and UEs not supporting on-demand SIB1 feature) can be barred using either: Option a) MIB barring, which should generally be the last option for barring, otherwise the SIB1 cannot be obtained by such UEs, which will not even be able to make emergency calls. An Option b) uses K_{SSB} as value 30. This will not lead the legacy UEs to look for SIB1 ‘elsewhere’ and can also signal an on-demand SIB1 feature capable UE to indicate that the cell is providing SIB1 on on-demand basis. The Option b) can be considered slightly better since it has the added advantage for the on-demand SIB1 feature capable UE and does not lead the legacy UEs to look for SIB1 ‘elsewhere’. So, using K_{SSB} value 30 in NES MIB is sufficient to effectively bar legacy UEs on an on-demand SIB1 cell when SIB1 is not being broadcast.

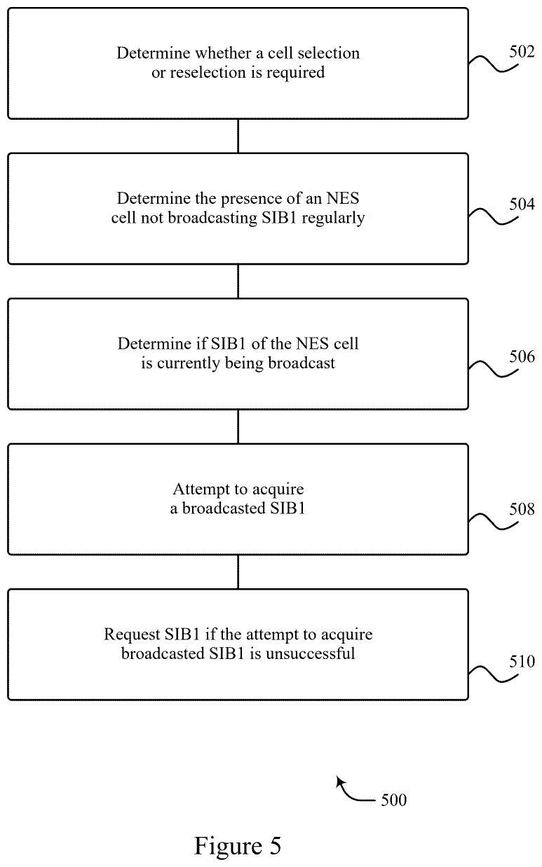

FIG. 5 illustrates an example procedure 500 for acquiring an on-demand SIB1, in accordance with aspects of the present disclosure. In this example 500, a UE initiates the procedure to select or reselect a cell in RRC idle and/or inactive mode. The UE determines whether a cell selection or reselection is required (at 502). The UE determines the presence of an NES cell not broadcasting SIB1 regularly (at 504), such as from the presence of some of the elements of SIB1-x or SIB1-y. The UE determines if SIB1 of the NES cell is currently being broadcast (at 506). The UE attempts to acquire a broadcasted SIB1 (at 508), such as if the SIB1 of the NES cell is currently being broadcast. The UE requests SIB1 if the attempt to acquire broadcasted SIB1 is unsuccessful (at 510) (or if the determination is that the cell is not currently broadcasting SIB1).

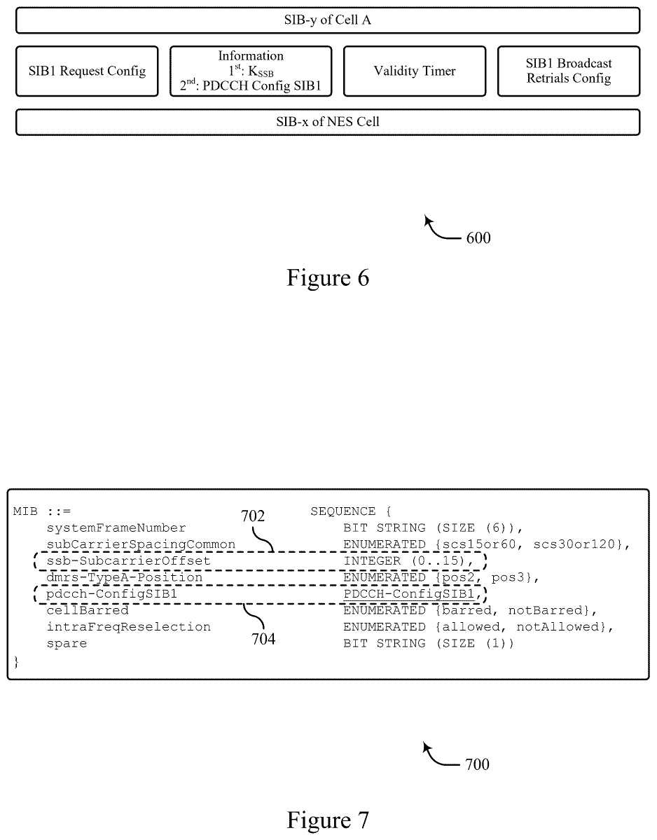

FIG. 6 illustrates an example 600 of SIB1 request configuration information, in accordance with aspects of the present disclosure. This example 600 indicates that a UE may acquire some of SIB1 request configuration (also referred to as WUS configuration), K_{SSB} (SSB subcarrier offset+1 bit) and PDCCH configuration to receive SIB1 from one of a NES cell and/or a serving cell (also referred to as cell A). The NES cell is the network cell that intends to save energy by not transmitting SIB1 regularly. Providing the information directly from the NES cell reduces dependency on an anchor cell (i.e., UEs may be able to camp on the NES cell directly and the cell can be used for cell selection as well). The SIB1 request configuration (e.g., a PRACH configuration), and K_{SSB} and PDCCH configuration for SIB1 reception can be provided by the NES cell in one of the system information blocks (SIB message, SIB-x).

Alternatively, the information SSB subcarrier offset and the PDCCH configuration for the UE to receive SIB1 can be provided in the MIB of the NES cell (e.g., as in legacy configuration). The SSB subcarrier offset can be extended using a bit included in PBCH to form K_{SSB}. When the NES cell provides the information for itself, the received information can be used by the UE to request SIB1 from the NES cell when it has stopped regular broadcasting of SIB1. This enables an energy saving deployment in environment scenarios when limited users are expected to be present, such as during evening and overnight hours. Additionally, the network operator and/or provider may not need to deploy another layer for providing an anchor cell.

The cell A is a network cell that provides some of SIB1 request configuration (also called WUS configuration), K_{SSB} (SSB subcarrier offset+1 bit) and PDCCH configuration to receive SIB1 of a NES cell in a SIB (SIB-y). For this purpose, the UE needs to acquire SIB-y from the cell A when the cell A is its serving cell. This may need an on-demand request for the SIB-y that carries the information for a neighboring NES cell.

FIG. 7 illustrates an example representation 700 of MIB, in accordance with aspects of the present disclosure. The SSB subcarrier offset 702 corresponds to K_{SSB} which is the frequency domain offset between SSB and the overall resource block grid in a number of subcarriers. The value range of this field (SSB subcarrier offset) may be extended by an additional most significant bit encoded within PBCH to form the K_{SSB}. The SSB subcarrier offset field in MIB may indicate that this cell does not provide SIB1 and therefore no CORESET #0 configured in MIB. In this case, the field PDCCH-ConfigSIB1 704 may indicate the frequency positions where the UE may (or may not) find a SS/PBCH with a control resource set and search space for SIB1.

In one or more implementations, cell A includes two parts information in SIB-y, likely together with a SIB1 request configuration. The first part information is similar to a legacy K_{SSB} parameter. The K_{SSB} is the frequency domain offset between SSB and the overall resource block grid in a number of subcarriers, and is an extension of SSB subcarrier offset. Generally, the value range of SSB subcarrier offset may be extended by an additional most significant bit encoded within PBCH to form K_{SSB}. However, when included as the first part information in cell A, this can be a single 5-bit long integer value (i.e., the UE need not be provided separately with a SSB subcarrier offset value and an additional most significant bit encoded within PBCH. The second part information is like PDCCH-ConfigSIB1 and indicates a common CORESET, a common search space, and PDCCH parameters to receive a broadcasted SIB1.

Alternatively, or in addition, to the two parts information being provided by the cell A, the same can be included by the NES cell itself in one of the SIB (SIB-x), where the SIB1 request configuration is included. Before using the SIB-x, the UE needs to verify if the same can be considered valid. For this purpose, a validity timer is included in SIB-x, and the UE considers the SIB-x to be valid as long as the validity timer is running (e.g., the timer started at the time of acquisition of SIB-x). When the UE has received these two parts information from SIB-y of cell A (or alternatively SIB-x of the NES cell), as well as from the MIB/PBCH of the NES cell, then the UE uses the information from only cell A to acquire SIB1 (i.e., the corresponding information from MIB/PBCH of the NES cell is ignored). If the UE has received the two parts information from cell A (or alternatively SIB-x of the NES cell), and the UE determines from K_{SSB} received from the NES cell (MIB/PBCH) that the NES cell supports on-demand SIB1 operation, the UE uses the information from only cell A to acquire SIB1 of the NES Cell (i.e., the corresponding information from MIB/PBCH of the NES cell is ignored).

In a legacy implementation, the SIB1 is transmitted on the DL-SCH with a periodicity of 160 ms and variable transmission repetition periodicity within 160 ms. The default transmission repetition periodicity of SIB1 is 20 ms, but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. This implementation avoids using the SSB subcarrier offset and PDCCH configuration from the MIB of the NES cell, which may be used in a repurposed way to signal that the SIB1 is not being transmitted regularly, or not currently, or to keep the legacy UEs away, to provide (or not provide) SIB1 in a different global synchronization channel number (GSCN), which may be the case when K_{SSB} is >23 for FR1 or >14 for FR2 (but not for K_{SSB}=30 for FR1 or 14 for FR2), etc.

In one or more implementations, when the UE has received the two parts information from cell A, as well as from the NES cell (MIB/PBCH), the UE uses the information only from the NES cell to acquire SIB1 (i.e., the corresponding information from cell A (or SIB-X of the NES Cell) is ignored. This implementation provides that the UE is trying to acquire broadcasted SIB1 based on the most recent configuration from the NES Cell, given that the MIB is always transmitted on the BCH with a periodicity of 80 ms and repetitions made within 80 ms. The MIB (PBCH) is part of a SSB transmission that the UE needs to receive anyway to have DL synchronization of the NES Cell.

In additional one or more implementations, a UE attempts SIB1 acquisition from the broadcasted channel of the NES cell. If the UE is able to acquire the SIB1, it goes on to camp on the cell. However, if the SIB1 acquisition is not considered successful, the UE shall go on to request SIB1 on an on-demand basis based on the SIB1 request configuration (also referred to as WUS configuration) acquired preferably from cell A if the SIB1 request configuration has been acquired recently (i.e., the SIB1 request configuration is considered valid), else from the NES cell. The UE does not consider the NES cell as barred before requesting the SIB1 on demand (i.e., if SIB1 acquisition from the broadcasted channel of the NES cell fails after a certain number of retrials, or time period, the UE goes on to request SIB1). The number of retrials or the time period of a UE attempt at acquiring a broadcasted SIB1 can be configured by the network as part of, or along with, WUS configuration, using parameters such as periodicity of intended SIB1 transmission pattern, a multiple thereof and/or a total length of time duration in milliseconds, slots, or a multiple thereof.

In additional one or more implementations, some specific values of K_{SSB}>23 (e.g., 25, 27) for FR1 and K_{SSB}>11 (e.g., 13) for FR2 and the WUS configuration available from cell A indicates that the SIB1 is currently being broadcast. In this case, the UE should attempt to acquire SIB1 according to the WUS configuration, and the UE should not transmit a SIB1 request while attempting to acquire SIB1. However, if the UE fails to acquire SIB1 broadcast, then the UE may initiate SIB1 request transmission. Beneficially detecting MIB barring bit to cellBarred indicates the Rel.19 NES UE of the interpretation of K_{SSB} specific values. Setting MIB barring bit to cellBarred has the additional benefit that legacy UEs shall consider the cell as barred and will therefore not attempt to acquire SIB1, saving battery power. Some remaining values of K_{SSB}>23 (e.g., 26, 28) for FR1 and K_{SSB}>11 (e.g., 12) for FR2 indicates to the UE that SIB1 is not currently being broadcast. In this case, the UE may directly initiate SIB1 request transmission. Beneficially detecting MIB barring bit to cellBarred tells the Rel. 19 NES UE of the interpretation of K_{SSB} specific values. Setting MIB barring bit to cellBarred has the additional benefit that legacy UEs shall consider the cell as barred and will therefore not attempt to acquire SIB1, saving battery power.

In additional one or more implementations, an intended outcome of the previous implementation is achieved using K_{SSB}=30 and by repurposing CORESET #0 and/or search space #0 conveyed by the NES Cell. Some of the repurposed code points of one or both of these two parameters indicate that SIB1 is currently being broadcast, and some of the remaining code points of one or both of these two parameters indicate that SIB1 is not currently being broadcast. Alternatively, K_{SSB}=30 is used when SIB1 is not being broadcast and another value of K_{SSB} is used when SIB1 is being broadcast. In the latter case, the K_{SSB} and PDCCH-ConfigSIB1 provide complete information for a UE to obtain SIB1 from the broadcast channel. In implementations, an explicit indication (e.g., with a value ‘True’) in MIB and/or in PBCH may be used to indicate that SIB1 is currently being broadcast. Alternatively, to indicate that SIB1 is not currently being broadcast, the other value (e.g., ‘False’) of the same explicit indication can be used.

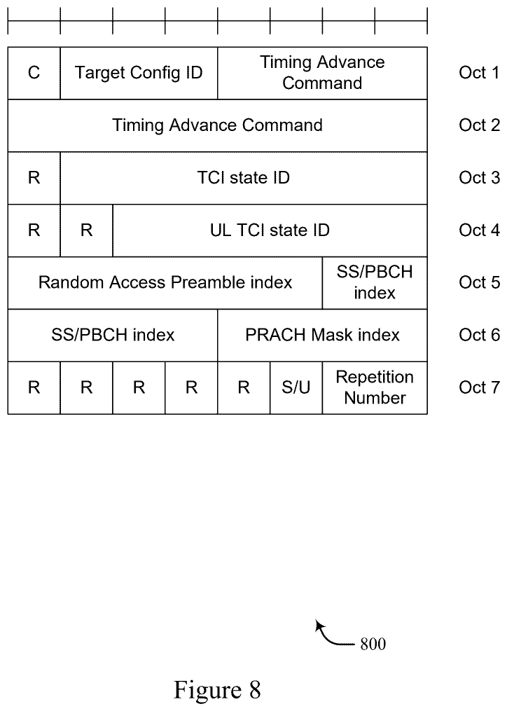

FIG. 8 illustrates an example 800 of LTM cell switch command MAC CE, in accordance with aspects of the present disclosure. In this example, a LTM cell switch command MAC CE is used to indicate early timing advance (TA), transmission configuration indicator (TCI) states, etc. without triggering a LTM mobility execution. The LTM Cell Switch Command MAC CE is identified by MAC subheader with eLCID, and has a variable size with several fields, as shown in this example 800.

A field R is a reserved bit, set to 0. A target configuration ID indicates the index of a candidate target configuration to apply for LTM cell switch, corresponding to ltm-CandidateId minus 1, and the length of the field is 3 bits. A field for timing advance command indicates whether the TA is valid for the LTM target cell (i.e., the SpCell corresponding to the target configuration indicated by the target configuration ID field). If the value of this field is set to FFF, this field indicates that no valid timing adjustment is available for the PTAG of the LTM target cell; otherwise, this field indicates the index value TA used to control the amount of timing adjustment that the MAC entity has to apply, and that the UE can skip the random access procedure for this LTM cell switch. If tag-Id-ptr is configured for the TCI state indicated by the UL TCI state ID field, if present, or by the TCI state ID field otherwise, in the LTM target cell and tag-Id-ptr is set to value n1, this field indicates the TA for the TAG indicated by the tag2-Id of the LTM target cell; otherwise, this field indicates the TA for the TAG indicated by the tag-id of the LTM target cell. The length of the field is 12 bits.

A field TCI state ID indicates and activates the TCI state for the LTM target cell (i.e., the SpCell of the target configuration indicated by the target configuration ID field). The TCI state is identified by TCI-StateId in ltm-DL-OrJointTCI-StateToAddModList. If the value of unifiedTCI-StateType in the ltm-TCI-Info of the configuration indicated by target configuration ID field is joint, this field is for joint TCI state, otherwise, this field is for downlink TCI state. The length of the field is 7 bits. A field UL TCI state ID indicates and activates the uplink TCI state for the LTM target cell (i.e., the SpCell of the target configuration indicated by the target configuration ID field). The UL TCI state is identified by TCI-UL-StateId in ltm-UL-TCI-StateToAddModList. The octet containing this field (i.e., this field and the two reserved bits in the same octet) is included if the value of unifiedTCI-StateType in the ltm-TCI-Info of the configuration indicated by Target Configuration ID field is separate. The length of the field is 6 bits.

A field C indicates the presence of the contention-free random access resources fields. If the value of this field is set to 1, the following fields are present: random access preamble index field, S/U field, SS/PBCH index field, PRACH mask index field, repetition number field and the reserved bits in the same octet. If the value of this field is set to 0, these fields are absent. A field S/U indicates which UL carrier to transmit the PRACH of the contention-free random access resources. If the value of this field is set to 1, SUL is used; otherwise, NUL is used. The length of the field is 1 bit. A field for random access preamble index indicates the random access preamble index of the contention-free random access resources. This field should not be set to 0b000000, and the length of the field is 6 bits. A field SS/PBCH index indicates the SS/PBCH that is used to determine the RACH occasion for the PRACH transmission of the contention-free random access resources. The length of the field is 6 bits.

A field PRACH mask index indicates the RACH occasion(s) associated with the SS/PBCH indicated by SS/PBCH index for the PRACH transmission of the contention-free random access resources. The field indicates a subset of RACH occasion(s) from the rach-ConfigDedicated for the UL carrier (indicated by S/U field), if provided, otherwise it indicates a subset of RACH occasion(s) from the rach-ConfigCommon for the UL carrier (indicated by S/U field) in the UL BWP configuration of firstActiveUplinkBWP-Id. When the repetition number field is not set to 0, the UE ignores this field, and the length of the field is 4 bits. A field repetition number indicates the Msg1 repetition number to be applied to the contention-free random access. If this field is set to 0, Msg1 repetition number does not apply. If this field is set to 1, the Msg1 repetition number is 2. If this field is set to 2, the Msg1 repetition number is 4. If this field is set to 3, the Msg1 repetition number is 8. The length of the field is 2 bits. As a note, a non-zero Msg1 repetition number value may only be included in the LTM Cell Switch Command MAC CE when the LTM target cell configuration has contention-based random access resources with a FeatureCombinationPreambles with the same Msg1 repetition number value and featureCombination indicating only msg1-Repetitions. As another note, if a UE receives the LTM cell switch command MAC CE with a target configuration ID value not matching any configured ltm-CandidateId minus 1, the procedure of handling LTM cell switch command MAC CE does not apply.

In one or more implementations, the network indicates that LTM execution is conditional based on the execution condition provided to the UE in an earlier RRC reconfiguration message, and this indication is made by using a special code point for “Target Config ID” (e.g., set to value 111). In other implementations, the purpose is achieved by using one of the reserved bits in the last OCTET when the field ‘C’ is set to 1. In other implementations, the purpose is achieved by using one of the reserved bits in the 3rd or 4th OCTET of the MAC CE.

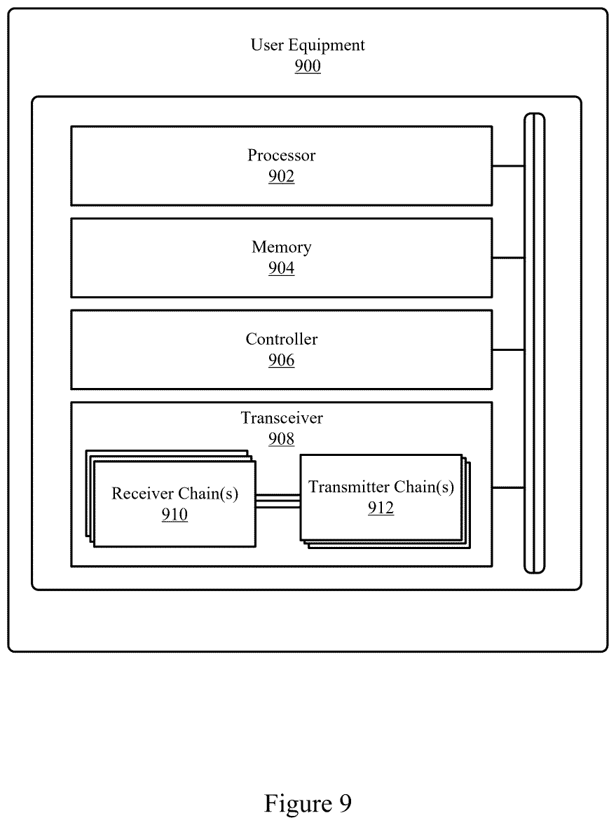

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for receiving, from a serving cell, a configuration that indicates first configuration information for requesting SIB1 and second configuration information that indicates one or more PRACH resources for requesting SIB1 of at least one NES cell; receiving, from the serving cell, information that indicates a SSB subcarrier offset and a PDCCH configuration for SIB1 acquisition from the at least one NES cell; and transmitting, to the at least one NES cell, a SIB1 request based on the first configuration information and a failed SIB1 acquisition.

Additionally, the UE 900 may be configured to support any one or combination of the method including camping on the at least one NES cell for service based on a successful SIB1 acquisition, where the NES cell is a subsequent serving cell for the UE. The method including receiving, from the at least one NES cell, an SSB that includes a MIB and a PBCH. The SSB subcarrier offset is an integer value that equals a frequency domain offset between an SSB and a RBG for a number of subcarriers. Based on the received information that indicates the SSB subcarrier offset and the PDCCH configuration for SIB1 acquisition, and based on the received SSB from the at least one NES cell indicating the SSB subcarrier offset and the PDCCH configuration for SIB1 acquisition, the method including processing the information received from the serving cell for SIB1 acquisition from the at least one NES cell. The method including monitoring for a broadcast SIB1 transmission based on one or more of the SSB subcarrier offset or the PDCCH configuration for SIB1 acquisition from the at least one NES cell; and determining a failed attempt for SIB1 acquisition based on the monitoring, where the SIB1 request is transmitted based on the determined failed attempt for SIB1 acquisition. The PDCCH configuration includes at least one or more of a CORESET, a CSS, or other PDCCH parameters.

Additionally, or alternatively, the UE 900 may support at least one memory (e.g., the memory 904) and at least one processor (e.g., the processor 902) coupled with the at least one memory and configured to cause the UE to receive, from a serving cell, a configuration that indicates first configuration information for requesting SIB1 and second configuration information that indicates one or more PRACH resources for requesting SIB1 of at least one NES cell; receive, from the serving cell, information that indicates a SSB subcarrier offset and a PDCCH configuration for SIB1 acquisition from the at least one NES cell; and transmit, to the at least one NES cell, a SIB1 request based on the first configuration information and a failed SIB1 acquisition.

Additionally, the UE 900 may be configured to support any one or combination of the at least one processor is configured to cause the UE to camp on the at least one NES cell for service based on a successful SIB1 acquisition, where the NES cell is a subsequent serving cell for the UE. The at least one processor is configured to cause the UE to receive, from the at least one NES cell, an SSB that includes a MIB and a PBCH. The SSB subcarrier offset is an integer value that equals a frequency domain offset between an SSB and a RBG for a number of subcarriers. Based on the received information that indicates the SSB subcarrier offset and the PDCCH configuration for SIB1 acquisition, and based on the received SSB from the at least one NES cell indicating the SSB subcarrier offset and the PDCCH configuration for SIB1 acquisition, the at least one processor is configured to cause the UE to process the information received from the serving cell for SIB1 acquisition from the at least one NES cell. The at least one processor is configured to cause the UE to monitor for a broadcast SIB1 transmission based on one or more of the SSB subcarrier offset or the PDCCH configuration for SIB1 acquisition from the at least one NES cell; and determine a failed attempt for SIB1 acquisition based on the monitoring, where the SIB1 request is transmitted based on the determined failed attempt for SIB1 acquisition. The PDCCH configuration includes at least one or more of a CORESET, a CSS, or other PDCCH parameters.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

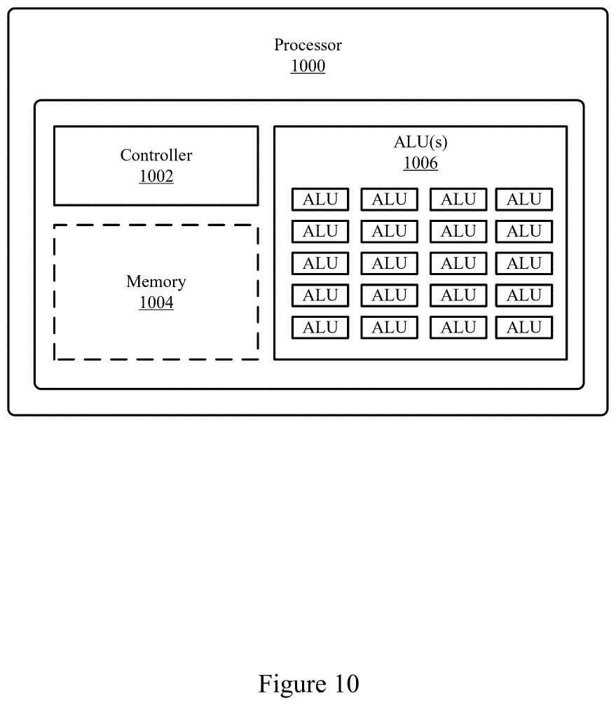

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to receive, from a serving cell, a configuration that indicates first configuration information for requesting SIB1 and second configuration information that indicates one or more PRACH resources for requesting SIB1 of at least one NES cell; receive, from the serving cell, information that indicates a SSB subcarrier offset and a PDCCH configuration for SIB1 acquisition from the at least one NES cell; and transmit, to the at least one NES cell, a SIB1 request based on the first configuration information and a failed SIB1 acquisition.

Additionally, the processor 1000 may be configured to or operable to support any one or combination of the at least one controller is configured to cause the processor to camp on the at least one NES cell for service based on a successful SIB1 acquisition, where the NES cell is a subsequent serving cell. The at least one controller is configured to cause the processor to receive, from the at least one NES cell, an SSB that includes a MIB and a PBCH. The SSB subcarrier offset is an integer value that equals a frequency domain offset between an SSB and a RBG for a number of subcarriers. Based on the received information that indicates the SSB subcarrier offset and the PDCCH configuration for SIB1 acquisition, and based on the received SSB from the at least one NES cell indicating the SSB subcarrier offset and the PDCCH configuration for SIB1 acquisition, the at least one controller is configured to cause the processor to process the information received from the serving cell for SIB1 acquisition from the at least one NES cell. The at least one controller is configured to cause the processor to monitor for a broadcast SIB1 transmission based on one or more of the SSB subcarrier offset or the PDCCH configuration for SIB1 acquisition from the at least one NES cell; and determine a failed attempt for SIB1 acquisition based on the monitoring, where the SIB1 request is transmitted based on the determined failed attempt for SIB1 acquisition. The PDCCH configuration includes at least one or more of a CORESET, a CSS, or other PDCCH parameters.

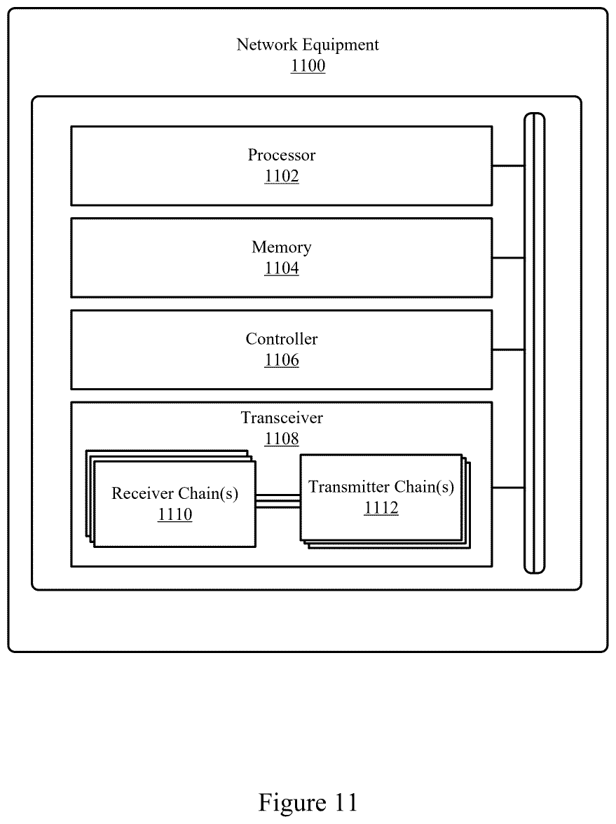

FIG. 11 illustrates an example of a NE 1100 in accordance with aspects of the present disclosure. The NE 1100 may be an example of a serving cell, a cell A, and/or a NES cell as described herein, and may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to or operable to support a means for transmitting, to a UE, a configuration that indicates first configuration information for requesting SIB1 and second configuration information that indicates one or more PRACH resources for requesting a SIB1 of at least one NES cell; and transmitting, to the UE, information that indicates a SSB subcarrier offset and a PDCCH configuration for SIB1 acquisition from the at least one NES cell, where a SIB1 request from the UE to the at least one NES cell is based on the first configuration information and a failed SIB1 acquisition.

Additionally, or alternatively, the NE 1100 may support at least one memory (e.g., the memory 1104) and at least one processor (e.g., the processor 1102) coupled with the at least one memory and configured to cause the NE to transmit, to a UE, a configuration that indicates first configuration information for requesting SIB1 and second configuration information that indicates one or more PRACH resources for requesting a SIB1 of at least one NES cell; and transmit, to the UE, information that indicates a SSB subcarrier offset and a PDCCH configuration for SIB1 acquisition from the at least one NES cell, where a SIB1 request from the UE to the at least one NES cell is based on the first configuration information and a failed SIB1 acquisition.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

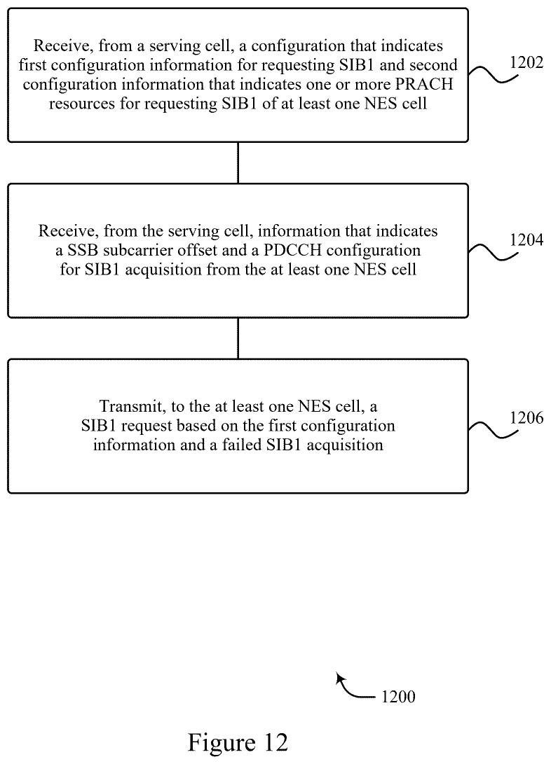

FIG. 12 illustrates a flowchart of a method 1200 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1202, the method may include receiving, from a serving cell, a configuration that indicates first configuration information for requesting SIB1 and second configuration information that indicates one or more PRACH resources for requesting SIB1 of at least one NES cell. The operations of 1202 may be performed in accordance with examples as described herein. In some implementations, aspects of the operations of 1202 may be performed by a UE as described with reference to FIG. 9.

At 1204, the method may include receiving, from the serving cell, information that indicates a SSB subcarrier offset and a PDCCH configuration for SIB1 acquisition from the at least one NES cell. The operations of 1204 may be performed in accordance with examples as described herein. In some implementations, aspects of the operations of 1204 may be performed by a UE as described with reference to FIG. 9.

At 1206, the method may include transmitting, to the at least one NES cell, a SIB1 request based on the first configuration information and a failed SIB1 acquisition. The operations of 1206 may be performed in accordance with examples as described herein. In some implementations, aspects of the operations of 1206 may be performed a UE as described with reference to FIG. 9.

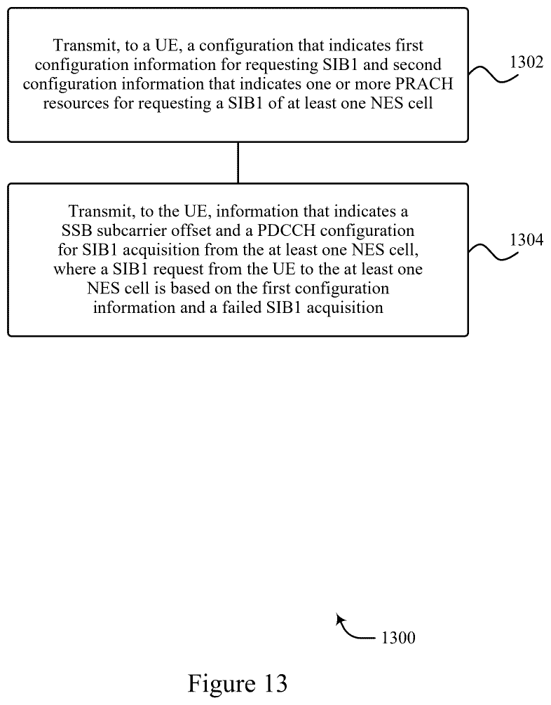

FIG. 13 illustrates a flowchart of a method 1300 in accordance with aspects of the present disclosure. The operations of the method may be implemented by a NE (e.g., a serving cell, or cell A) as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include transmitting, to a UE, a configuration that indicates first configuration information for requesting SIB1 and second configuration information that indicates one or more PRACH resources for requesting a SIB1 of at least one NES cell. The operations of 1302 may be performed in accordance with examples as described herein. In some implementations, aspects of the operations of 1302 may be performed by a NE as described with reference to FIG. 11.

At 1304, the method may include transmitting, to the UE, information that indicates a SSB subcarrier offset and a PDCCH configuration for SIB1 acquisition from the at least one NES cell, wherein a SIB1 request from the UE to the at least one NES cell is based on the first configuration information and a failed SIB1 acquisition. The operations of 1304 may be performed in accordance with examples as described herein. In some implementations, aspects of the operations of 1304 may be performed by a NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a serving cell, a configuration that indicates first configuration information for requesting system information block 1 (SIB1) and second configuration information that indicates one or more physical random access channel (PRACH) resources for requesting SIB1 of at least one network energy saving (NES) cell;
receive, from the serving cell, information that indicates a synchronization signal block (SSB) subcarrier offset and a physical downlink control channel (PDCCH) configuration for SIB1 acquisition from the at least one NES cell; and
transmit, to the at least one NES cell, a SIB1 request based at least in part on the first configuration information and a failed SIB1 acquisition.

2. The UE of claim 1, wherein the at least one processor is configured to cause the UE to camp on the at least one NES cell for service based at least in part on a successful SIB1 acquisition, wherein the NES cell is a subsequent serving cell for the UE.

3. The UE of claim 1, wherein the at least one processor is configured to cause the UE to receive, from the at least one NES cell, an SSB that includes a master information block (MIB) and a physical broadcast channel (PBCH).

4. The UE of claim 3, wherein the SSB subcarrier offset is an integer value that equals a frequency domain offset between an SSB and a resource block grid (RBG) for a number of subcarriers.

5. The UE of claim 3, wherein:
based at least in part on the received information that indicates the SSB subcarrier offset and the PDCCH configuration for SIB1 acquisition, and
based at least in part on the received SSB from the at least one NES cell indicating the SSB subcarrier offset and the PDCCH configuration for SIB1 acquisition, the at least one processor is configured to cause the UE to:
process the information received from the serving cell for SIB1 acquisition from the at least one NES cell.

6. The UE of claim 5, wherein the at least one processor is configured to cause the UE to:
monitor for a broadcast SIB1 transmission based at least in part on one or more of the SSB subcarrier offset or the PDCCH configuration for SIB1 acquisition from the at least one NES cell; and
determine a failed attempt for SIB1 acquisition based at least in part on the monitoring,
wherein the SIB1 request is transmitted based at least in part on the determined failed attempt for SIB1 acquisition.

7. The UE of claim 1, wherein the PDCCH configuration includes at least one or more of a common control resource set (CORESET), a common search space (CSS), or other PDCCH parameters.

8. A processor for wireless communication, comprising:
at least one controller coupled with at least one memory and configured to cause the processor to:
receive, from a serving cell, a configuration that indicates first configuration information for requesting system information block 1 (SIB1) and second configuration information that indicates one or more physical random access channel (PRACH) resources for requesting SIB1 of at least one network energy saving (NES) cell;
receive, from the serving cell, information that indicates a synchronization signal block (SSB) subcarrier offset and a physical downlink control channel (PDCCH) configuration for SIB1 acquisition from the at least one NES cell; and
transmit, to the at least one NES cell, a SIB1 request based at least in part on the first configuration information and a failed SIB1 acquisition.

9. The processor of claim 8, wherein the at least one controller is configured to cause the processor to camp on the at least one NES cell for service based at least in part on a successful SIB1 acquisition, wherein the NES cell is a subsequent serving cell.

10. The processor of claim 8, wherein the at least one controller is configured to cause the processor to receive, from the at least one NES cell, an SSB that includes a master information block (MIB) and a physical broadcast channel (PBCH).

11. The processor of claim 10, wherein the SSB subcarrier offset is an integer value that equals a frequency domain offset between an SSB and a resource block grid (RBG) for a number of subcarriers.

12. The processor of claim 10, wherein:
based at least in part on the received information that indicates the SSB subcarrier offset and the PDCCH configuration for SIB1 acquisition, and
based at least in part on the received SSB from the at least one NES cell indicating the SSB subcarrier offset and the PDCCH configuration for SIB1 acquisition, the at least one controller is configured to cause the processor to:
process the information received from the serving cell for SIB1 acquisition from the at least one NES cell.

13. The processor of claim 12, wherein the at least one controller is configured to cause the processor to:
monitor for a broadcast SIB1 transmission based at least in part on one or more of the SSB subcarrier offset or the PDCCH configuration for SIB1 acquisition from the at least one NES cell; and
determine a failed attempt for SIB1 acquisition based at least in part on the monitoring,
wherein the SIB1 request is transmitted based at least in part on the determined failed attempt for SIB1 acquisition.

14. The processor of claim 8, wherein the PDCCH configuration includes at least one or more of a common control resource set (CORESET), a common search space (CSS), or other PDCCH parameters.

15. A method performed by a user equipment (UE), the method comprising:
receiving, from a serving cell, a configuration that indicates first configuration information for requesting system information block 1 (SIB1) and second configuration information that indicates one or more physical random access channel (PRACH) resources for requesting SIB1 of at least one network energy saving (NES) cell;
receiving, from the serving cell, information that indicates a synchronization signal block (SSB) subcarrier offset and a physical downlink control channel (PDCCH) configuration for SIB1 acquisition from the at least one NES cell; and
transmitting, to the at least one NES cell, a SIB1 request based at least in part on the first configuration information and a failed SIB1 acquisition.

16. The method of claim 15, further comprising camping on the at least one NES cell for service based at least in part on a successful SIB1 acquisition, wherein the NES cell is a subsequent serving cell for the UE.

17. The method of claim 15, further comprising receiving, from the at least one NES cell, an SSB that includes a master information block (MIB) and a physical broadcast channel (PBCH).

18. The method of claim 17, wherein:
based at least in part on the received information that indicates the SSB subcarrier offset and the PDCCH configuration for SIB1 acquisition, and
based at least in part on the received SSB from the at least one NES cell indicating the SSB subcarrier offset and the PDCCH configuration for SIB1 acquisition, the method further comprising:
processing the information received from the serving cell for SIB1 acquisition from the at least one NES cell.

19. The method of claim 18, further comprising:
monitoring for a broadcast SIB1 transmission based at least in part on one or more of the SSB subcarrier offset or the PDCCH configuration for SIB1 acquisition from the at least one NES cell; and
determining a failed attempt for SIB1 acquisition based at least in part on the monitoring,
wherein the SIB1 request is transmitted based at least in part on the determined failed attempt for SIB1 acquisition.

20. A network equipment (NE) for wireless communication, comprising:
at least one memory; and
at least one processor coupled with the at least one memory and configured to cause the NE to:
transmit, to a user equipment (UE), a configuration that indicates first configuration information for requesting system information block 1 (SIB1) and second configuration information that indicates one or more physical random access channel (PRACH) resources for requesting a SIB1 of at least one network energy saving (NES) cell; and
transmit, to the UE, information that indicates a synchronization signal block (SSB) subcarrier offset and a physical downlink control channel (PDCCH) configuration for SIB1 acquisition from the at least one NES cell, wherein a SIB1 request from the UE to the at least one NES cell is based at least in part on the first configuration information and a failed SIB1 acquisition.
